(19) United States
(12) Patent Application Publication
(10) Pub. No.: US 2010/0238512 A1
(43) Pub. Date: Sep. 23, 2010

(54) INFORMATION PROCESSING APPARATUS, PRINTING APPARATUS, INFORMATION PROCESSING METHOD, AND PRINTING METHOD

(75) Inventor: Yusuke Kimura, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/724,759

(22) Filed: Mar. 16, 2010

(30) Foreign Application Priority Data
Mar. 23, 2009 (JP) 2009-070867

(51) Int. Cl. G06K 15/02

(52) U.S. Cl. 358/3.24; 358/1.14

(57) ABSTRACT

An information processing apparatus includes a designation unit configured to designate a concealing procedure of variable data relating to print data containing reusable data and variable data, an attribute addition unit configured to add, according to the concealing procedure designated by the designation method, concealment attributes relating to the concealing procedure of the variable data, to print attributes of the print data in association with the variable data, and a transferring unit configured to transfer a print job containing information relating to the print data and the print attributes to which the concealment attributes have been added by the attribute addition unit, to a printing apparatus.

### BACKGROUND OF THE INVENTION

1. Field of the Invention

The present invention relates to an information processing apparatus, a printing apparatus, an information processing method, and a printing method.

2. Description of the Related Art

Attention needs to be paid to information leakage during document processing. Thorough security management is required for information held at a company. Hence, measures must be taken to discard unnecessary printed matters by a shredder or solution processing. In reality, however, in the present situation, at an Office Automation (OA) corner of a printing house or a company, test-printed matters are left vulnerable in terms of personal information protection. Especially, in the case of mass printing, such as Variable Data Printing (VDP), test printing is frequently performed to generate a large number of printed matters containing personal information.

A specific information leakage case may be the outflow of information caused when such printed matters is brought outside or personal information of the printed matters is memorized by an operator. For the purpose of preventing information leakage, therefore, a personal information portion must be concealed when making prints during test printing.

Under such circumstances, a concealment processing technology that prevents information leakage has conventionally been provided. This technology enables preventing leakage of classified information to a third party by extracting a classified information portion during printing. The extracted portion is to be a turned letter or concealed. An administrator can instruct this concealment processing.

Another approach that simultaneously enables prevention of information leakage, and re-utilization of paper has been proposed. More specifically, test printing is performed as normally practiced, and a printed matter is set in an optional paper feed tray after confirmation of contents (determination of contents) of the printed matter. This technology feeds paper from a designated paper feed tray (tray in which the printed matter is set) and performs concealment processing on a classified information portion of the test-printed matter and re-printing (overprinting) is executed (see Japanese Patent Application Laid-Open No. 2007-313662, hereinafter Japan '662).

The technology discussed in Japan '662 is advantageous in that the concealment processing is performed on the test-printed matter to enable concealment of information and re-utilization of paper. However, when each information, such as a character or an image, is replaced to perform printing for each paper as in the case of VDP, the technology of Japan '662 is not the best. If the number of copies is small, a procedure of performing test printing and executing re-printing to apply concealment processing after confirmation of contents, as in the case of the technology of Japan '662, can be repeated. However, when mass printing is performed, as in the case of VDP, repetition of confirmation and concealment is inefficient.

Further, in VDP, a character or an image changes from one printed matter to another, and hence it may not be document contents, such as errors in writing, but tints that must be confirmed by test printing. Thus, points to be checked by test printing are different from those in the conventional case. The technology of Japan '662 extracts a classified information portion from all document/image data when the classified information portion is determined. In VDP, portions containing classified information and personal information are included in variable data, and extracting them from all the data is not efficient.

### SUMMARY OF THE INVENTION

According to an aspect of the present invention, an information processing apparatus includes a designation unit configured to designate a concealing procedure of information contained in variable data relating to print data containing reusable data and the variable data, an attribute addition unit configured to add, according to the concealing procedure designated by the designation unit, concealment attributes of the variable data whose concealing procedure has been designated by the designation unit, to print attributes of the print data, and a transferring unit configured to transfer a print job containing the print attributes to which the concealment attributes have been added by the attribute addition unit and the print data, to a printing apparatus.

According to another aspect of the present invention, a printing apparatus includes a reception unit configured to receive a print job containing print data containing reusable data and variable data, and print attributes containing concealment attributes of the variable data of the print data, and a generation unit configured to generate, when a command to output copy is received, a concealed image concealing the variable data corresponding to the concealment attributes, based on the concealment attributes contained in the print attributes of the print job received by the reception unit.

According to the present invention, information leakage during outputting copy in test printing can be efficiently prevented.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a printing system.

FIG. 2 illustrates an example of a data structure of Portable Document Format/Variable Transactional (PDF/VT).

FIG. 3 illustrates an example of a screen displayed on a display via an Operating System (OS) after an editor is activated. The screen is based on source information of a Graphical User Interface (GUI) screen generated by the editor that is a VDP data generation/editing application (program).

FIG. 4 illustrates an example of a hardware configuration of a host computer and a printing apparatus.

FIGS. 5A and 5B illustrate examples of variable data structures.

FIG. 6 illustrates a first example (1) of a functional configuration of the host computer and the printing apparatus.

FIGS. 7A and 7B illustrate examples of VDP data.

FIG. 8 is a flowchart illustrating an example of processing concerning a generation of a normal image or a concealed image.

FIGS. 9A to 9C illustrate examples of printing results.

FIG. 10 is a flowchart illustrating an example of printing in the printing apparatus.

FIG. 11 illustrates an example of a screen displayed on a panel.

FIG. 12 illustrates a second example (2) of a functional configuration of the host computer and the printing apparatus.

FIG. 13 is a flowchart illustrating an example of allocation and execution of concealment processing.

### DESCRIPTION OF THE EMBODIMENTS

Various exemplary embodiments, features, and aspects of the invention will be described in detail below with reference to the drawings.

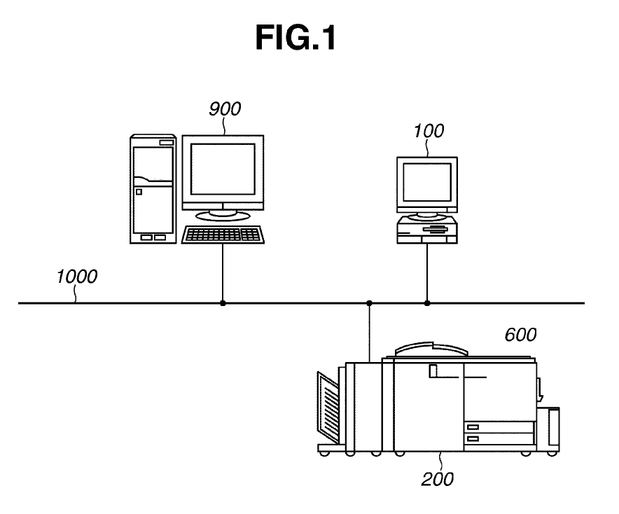

FIG. 1 illustrates an example of a configuration of a printing system. The printing system illustrated in FIG. 1 includes, as components, a host computer 100, a printing apparatus 200, and a database (DB) server 900 that stores variable data. These components of the printing system are connected to one and the same network 1000. The printing apparatus 200 is the same as a normal printing apparatus in configuration except that it can print variable data. The printing apparatus 200 includes an operation panel 600.

There is a Personalized Print Markup Language (PPML) as a format designed to efficiently print variable data. Another format of Portable Document Format/Variable Transactional (PDF/VT) is currently under study. As of December of 2008, the PDF/VT is in the middle of standardization. In this specification, PDF/VT is used as an example of Variable Data Printing (VDP) data.

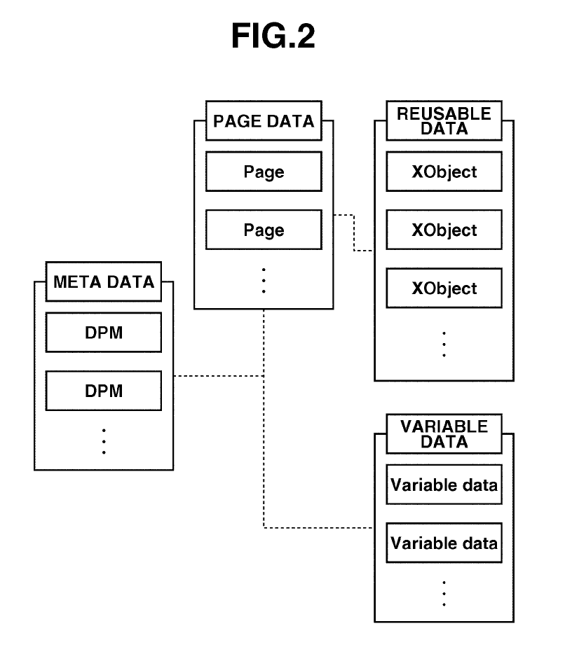

FIG. 2 illustrates an example of a data structure of PDF/VT. The PDF/VT data structure of FIG. 2, and data used a plurality of times (reusable data) is defined by X Object and can be referred to from a plurality of pages. Variable data, such as personal information, is described as variable data. When printed matter creation requires special setting, the setting can be described using Document Print Metadata (DPM).

A VDP data generation/editing application in the host computer 100 of this system will now be described.

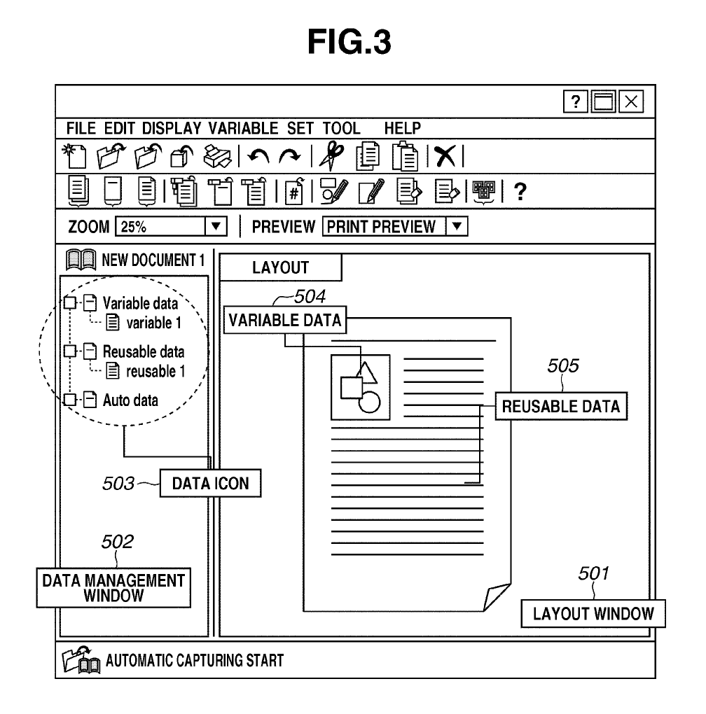

FIG. 3 illustrates an example of a screen displayed on a display via an Operating System (OS) after an editor is activated. The screen is based on source information of a Graphical User Interface (GUI) screen generated by the editor that is a VDP data generation/editing application (program).

On the GUI screen, two windows, i.e., a layout window 501 for displaying arrangement of data on a sheet and a data management window 502 for displaying a list of data formats in a tree shape, are simultaneously displayed, and can be closed as occasion demands. The tree-shaped displaying on the data management window 502 is referred to as a data icon 503, where individual data are displayed side by side under data formats. Variable data 504 and reusable data 505 displayed in the layout window 501 correspond one-to-one to the data icon 503 of the data management window 502.

Each data has data attributes. The data attributes include a data identifier (ID), a data name, a data format, and a concealment means.

The data ID is a unique numeral to identify data in the program. The data name is a unique character string that enables a user to distinguish data.

The data format takes a reusable, variable or auto value. Data having a fixed format is data common (reusable) among print pages. Examples of data having fixed formats are a background image and a basic layout. Data having a variable format is data that changes from one print page to another. Examples of data having variable formats are a name, personal ID, an address, and a face picture. Data having an auto format is data automatically generated by the VDP data generation/editing program. Examples of data having auto formats are a printing start date and time, and a print page.

Only the administrator is permitted to set the concealment means. An unauthorized user is not permitted to set the concealment means. Only data having a variable format has attributes of the concealment means. The attributes of the concealment means designate a concealing procedure how variable data is concealed when copying and outputting are performed during test printing.

When data is a character string, a user can select “NOT CONCEAL”, “REPLACE”, “NOT PRINT”, or other designated terms, for the concealment means. “NOT CONCEAL” means that selected variable data is printed without being concealed. “REPLACE” means that dummy data for concealment pre-registered in the DB server 900 is replaced by setting a character of the same type. “NOT PRINT” means that variable data is not printed. “REPLACE” includes exception processing for making automatic adjustment to set the numbers of characters to be the same without destroying a layout.

When data is an image, the user can select “NOT CONCEAL”, “MOSAIC”, “NOT PRINT”, or other designated terms, for the concealment means. “NOT CONCEAL” and “NOT PRINT” are similar in meaning to those in the case of the character string. “MOSAIC” means that image data is printed with mosaic patterns. A mosaic level can be set in this application.

The following procedure is an example of attribute setting of variable data performed by the administrator. The administrator clicks a right mouse button on the data icon 503 to make additions. The administrator adds variable data to the data icon 503 by designating a DB of a data obtaining destination and its reference position on a setting screen during generation. Alternatively, the administrator adds variable data to the data icon 503 by designating a DB of an obtaining destination of the variable data to be added and its reference position from the variable of the menu. The administrator selects a setting menu on the data icon 503 by clicking the right mouse or opens an attribute setting screen of the selected variable data to set attributes, from the setting of the menu.

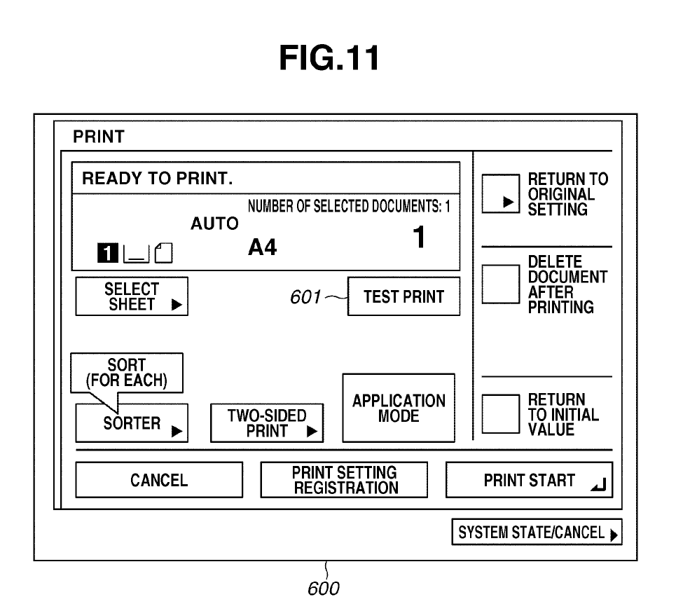

When performing printing according to this program, the user can designate pages of not only normal printing but also test printing before a job entry. Further, for a job format, the user can select a format of PDF/VT or PPML. In the case of inputting a job according to this program, the user can issue a concealment printing command to the printing apparatus 200 by a designated format according to concealment attributes. Even when the program side (host computer 100 side) designates no test printing, concealment printing can be performed if the user instructs test printing via a screen illustrated in FIG. 11 in the printing apparatus 200 side.

Concealment attributes are embedded as meta data (or print attributes) in the print job generated by this program. In the case of PDF/VT, concealment attributes or special print setting (print attributes) is described in DPM.

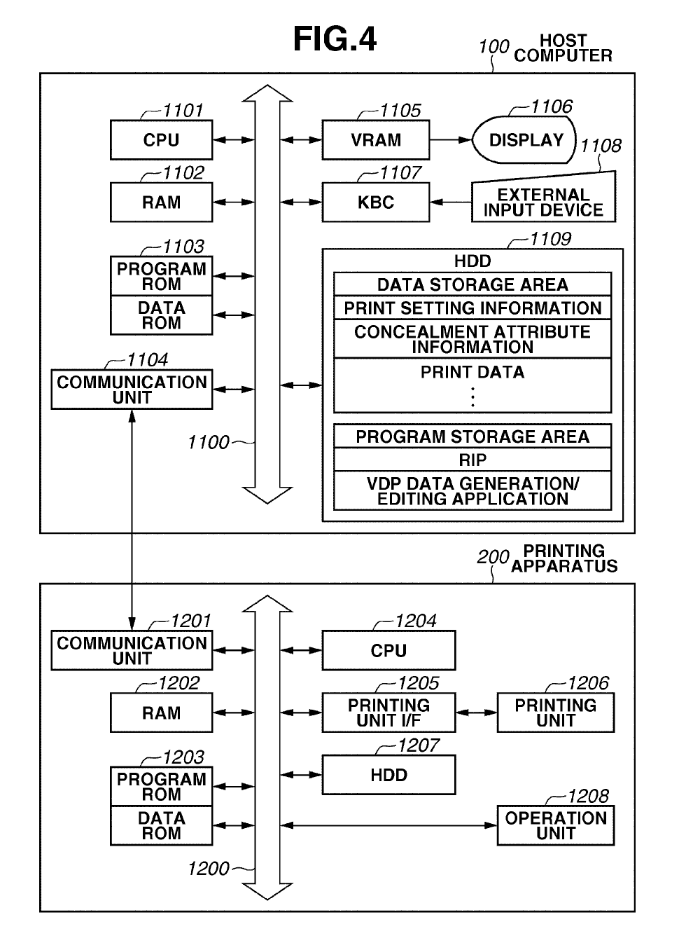

FIG. 4 illustrates an example of a hardware configuration of the host computer and the printing apparatus. The host computer 100 can be realized by a general-purpose PC.

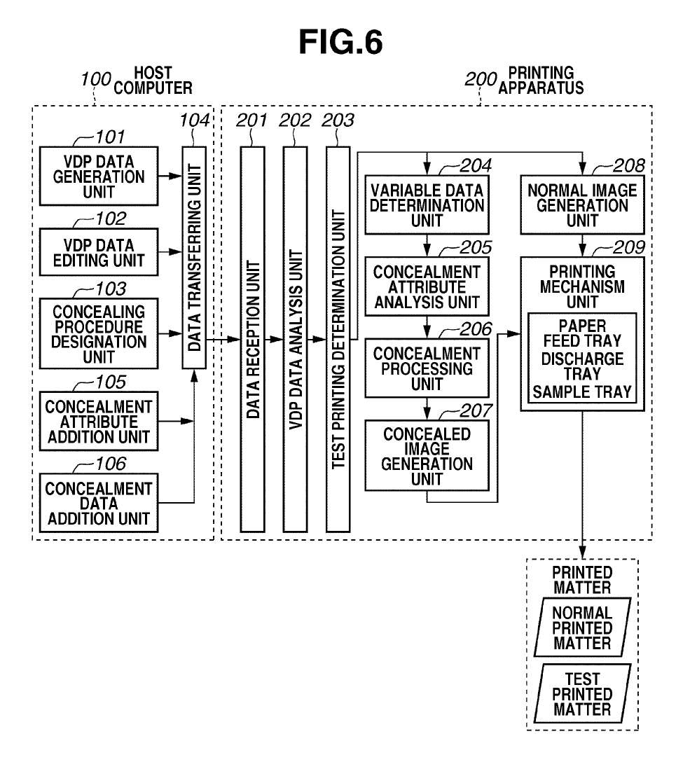

A Central Processing Unit (CPU) 1101 controls the host computer 100. A Random Access Memory (RAM) 1102 functions as a main memory of the CPU 1101 to provide a work area or a temporary saving area of an execution program. For example, the CPU 1101 reads a VDP data generation/editing application from a memory, such as a Hard Disk Drive (HDD) 1109, and executes the application, thereby realizing functions of units 101 to 106 of FIG. 6 described below. Alternatively, the RAM 1102 is used as a work area for updating concealment attribute information.

A Read Only Memory (ROM) 1103 stores an operation procedure (program) of the CPU 1101. The ROM 1103 includes a program ROM for recording a system program or Operating System (OS) to control the host computer 100 or a program represented by a processing flow described below and a data ROM for storing information necessary for operating the system.

A communication unit 1104 controls data transfer between the printing apparatus 200 via a network. A video RAM (VRAM) 1105 rasterizes an image indicating a system operation state or a User Interface (UI) of this exemplary embodiment to be displayed on a screen of a display 1106 to control the display. An external input device 1108, generally a keyboard or a pointing device (mouse), receives an operation from the user. A Keyboard Controller (KBC) 1107 controls an input signal from the external input device such as a keyboard or a pointing device.

The HDD 1109 is used for storing VDP data generated by a VDP data generation unit 101. The HDD 109 stores print data and concealment attribute information (concealment attributes) added by a concealment attribute addition unit 105 described below. The HDD 109 may store each program, which is written in the RAM 1102 and executed.

An Input/Output (I/O) bus (address bus, data bus or control bus) 1100 interconnects the aforementioned units.

In the printing apparatus 200, a CPU 1204 controls the printing apparatus 200, and executes a control program stored in the program ROM of a ROM 1203 or a control program stored in a HDD 1207. For example, the CPU 1204 executes a control program read from a memory, such as the HDD 1207, to realize functions indicated by units 202 to 208 of FIG. 6 described below. The CPU 1204 comprehensively controls access with various devices connected to a system bus 1200, and outputs an image signal as output information to a printing unit 1206 connected via a printing unit interface (I/F) 1205.

A RAM 1202 functions as a main memory or a work area of the CPU 1204. The RAM 1202 is configured to increase a memory capacity by an optional RAM connected to an expansion port (not illustrated).

The HDD 1207 stores a program to realize a VDP data analysis unit 202 or a concealed image generation unit 207 of FIG. 6 described below. A communication unit 1201 controls data transfer between the host computer 100 via the network. An operation unit 1208 includes an operation panel 600. The user can operate the printing apparatus 200 from the operation unit 1208.

The DB server 900 has a hardware configuration similar to that of the host computer 100, and a HDD of the DB server 900 stores a DB. A CPU of the DB server 900 executes processing based on a program stored in the HDD of the DB server 900 to realize a function of the DB server 900.

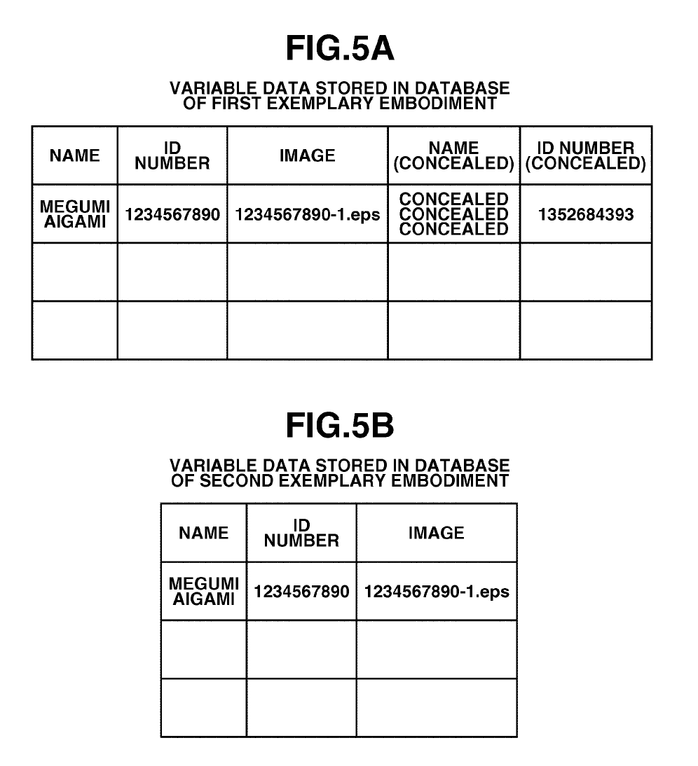

A first exemplary embodiment will be described by way of example where the host computer side generates dummy data for concealment. Data stored in the DB server 900 is variable data managed in a form illustrated in FIG. 5A. FIGS. 5A and 5B illustrate examples of variable data structures. In the first exemplary embodiment, the DB server 900 has variable data and dummy data to be used during concealment processing stored beforehand correspondingly to each other.

FIG. 6 illustrates a first example (1) of a functional configuration of the host computer and the printing apparatus.

As illustrated in FIG. 6, the host computer 100 includes, as functional components, a VDP data generation unit 101, a VDP data editing unit 102, a concealing procedure designation unit 103, a concealment attribute addition unit 105, a concealment data addition unit 106, and a data transferring unit 104.

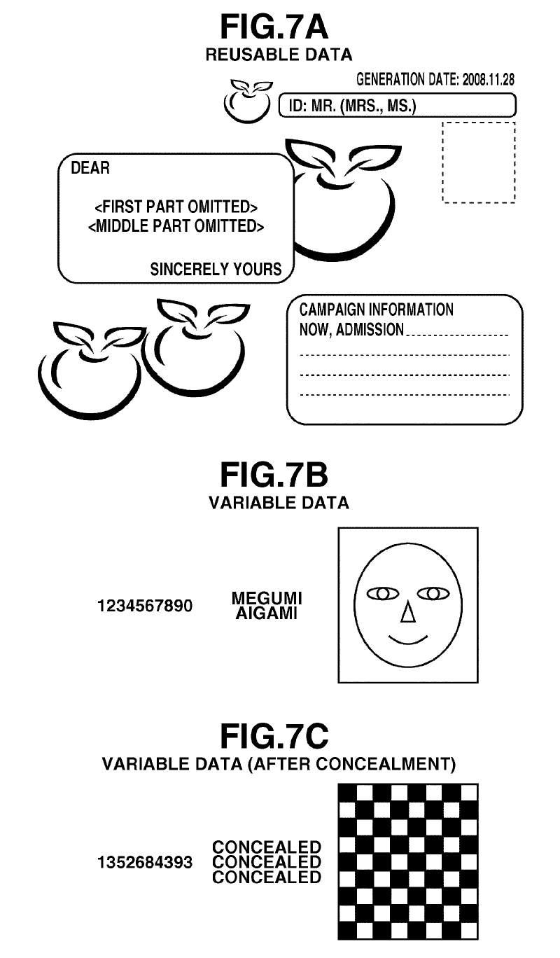

The VDP data generation unit 101 activates an application illustrated in FIG. 3 that enables generation of VDP data in a format for printing viable data used for printing in the printing apparatus 200. In the host computer 100, the user can optionally generate VDP data by using the application. Generated data are in concrete terms data containing objects illustrated in FIGS. 7A to 7C. FIGS. 7A to 7C illustrate examples of VDP data.

The VDP data editing unit 102 edits VDP data based on an editing operation performed by the user via the application.

The concealing procedure designation unit 103 designates, based on a designation operation to designate administrator's concealing procedure via the application, a concealment means (concealing procedure) as an attribute for variable data of VDP data. For a reason of security, only the administrator is permitted to set a detailed method for concealing information contained in the variable data.

The concealment attribute addition unit 105 adds a concealment attribute designated by the concealing procedure designation unit 103 to a print attribute (meta data) of print data in association with related (or designated) variable data.

To enable reference to the dummy data for concealment in the printing apparatus 200 side, the concealment data addition unit 106 embeds both of variable data for normal printing and variable data (dummy data) for concealed printing in the print data. In the case of configurations illustrated in FIG. 1 and FIG. 5A, in reality, the concealment data addition unit 106 embeds a path of the variable data for normal printing on the DB server 900 and a path of dummy data on the DB server 900 corresponding to the variable data in the print data. To simplify description, however, a simple expression such as embedding of variable data in the print data or extraction of variable data from the print data may also be used.

In the case of a configuration where no DB server is provided in the printing system, in the host compute 100 side, not a path but real variable data may be contained in the print data. Similarly, in the printing apparatus 200 side, real variable data may be extracted from the print data to be printed.

The data transferring unit 104 converts VDP data containing the dummy data added by the concealment data addition unit 106 in the print data and the concealment attribute added by the concealment attribute addition unit 105, as the meta data into a description form to be interpreted by a printing apparatus of a transfer destination. The description form to be interpreted by the printing apparatus is, for example, PDF/VT or PPML. The data transferring unit 104 transfers data generated as a result of the conversion as a print job to the printing apparatus 200.

The printing apparatus 200 includes a data reception unit 201, a VDP data analysis unit 202, a test printing determination unit 203, a variable data determination unit 204, a concealment attribute analysis unit 205, a concealment processing unit 206, a concealed image generation unit 207, a normal image generation unit 208, and a printing mechanism unit 209.

The data reception unit 201 receives the VDP data (or print job) transferred from the data transferring unit 104 of the host computer 100. The data reception unit 201 passes the received data to the VDP data analysis unit 202.

The VDP data analysis unit 202 analyzes the received VDP data, and separates a print attribute portion (meta data) and a print data portion (page data, reusable data, and variable data) from the received VDP data. The variable data of the print data portion contains both of the print data for normal printing and the print data (dummy data) for concealed printing.

The test printing determination unit 203 determines whether there is a test printing command based on the separated print attribute portion or an operation performed by the user via the operation panel 600. If there is no test printing command, the normal image generation unit 208 generates a normal image to perform normal printing, and transmits data to the printing mechanism unit 209.

On the other hand, if there is a test printing command, the variable data determination unit 204 determines whether the print data portion contains variable data based on the meta data. If the print data portion contains variable data, for example, the variable data determination unit 204 extracts the variable data from the print data portion. The extraction in this case includes, if the print data portion contains a path of the variable data as described above, acquisition of relevant variable data from the DB server 900 based on the path.

The concealment attribute analysis unit 205 analyzes the meta data of the VDP data to identify a concealing procedure (concealment attribute) of the variable data.

The concealment processing unit 206 executes, according to the concealment attribute identified by the concealment attribute analysis unit 205, concealment processing, such as replacement or mosaic patterning, for the relevant variable data obtained by the variable data determination unit 204. The concealed image generation unit 207 generates a concealed image containing the variable data subjected to the concealment processing by the concealment processing unit 206 based on the VDP data. The VDP data contains layout data relating to a layout of the reusable data or the variable data.

An output from the normal image generation unit 208 or an output from the concealed image generation unit 207 is passed to the printing mechanism unit 209 to perform final printing. The printing mechanism unit 209 is a print engine that performs actual printing on a print sheet.

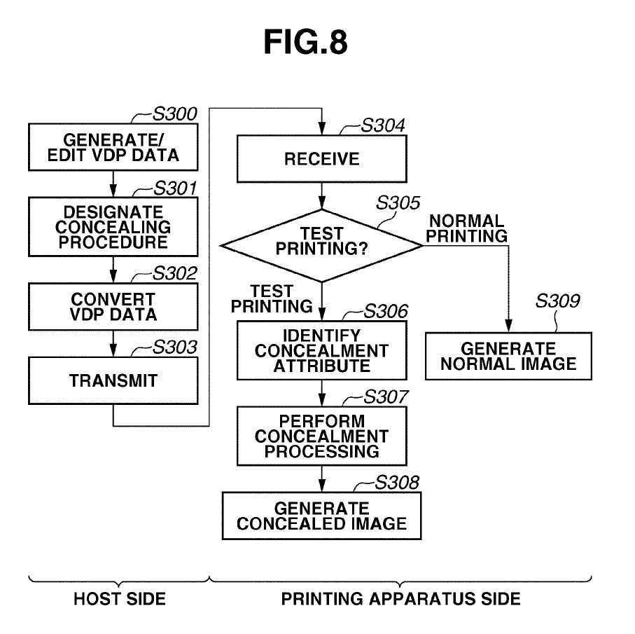

FIG. 8 is a flowchart illustrating an example of processing relating to a generation operation of a normal image or a concealed image.

First, in step S300, in the host computer 100 side, the VDP data generation unit 101 or the VDP data editing unit 102 generates or edits VDP data illustrated in FIGS. 7A to 7C based on user's operation. In step S301, the concealing procedure designation unit 103 designates a concealing procedure for a variable data portion of the data based on the operation. The concealment attribute addition unit 105 adds concealment attributes to meta data of the VDP data according to the designated concealing procedure. The concealment data addition unit 106 adds concealment data that is dummy data of the variable data whose concealing procedure has been designated, to, for example, print data of the VDP data.

For a reason of security, only a user having an administrator right is permitted to designate a concealing procedure (setting of concealment attributes). Attributes designated by the administrator are reflected on meta data of users having no rights.

In step S302, the data transferring unit 104 converts the VDP data into a format (PDF/VT or PPML) suitable for VDP printing to generate a print job. In step S303, the data transferring unit 104 transmits the print job to the printing apparatus 200. The above processing is performed in the host computer 100 side.

In step S304, the data reception unit 201 receives the print job transmitted from the host computer 100. The data reception unit 201 passes the received print job to the VDP data analysis unit 202. In this case, the data reception unit 201 repeats the processing until the print job is completed, and continuously passes received data to the VDP data analysis unit 202.

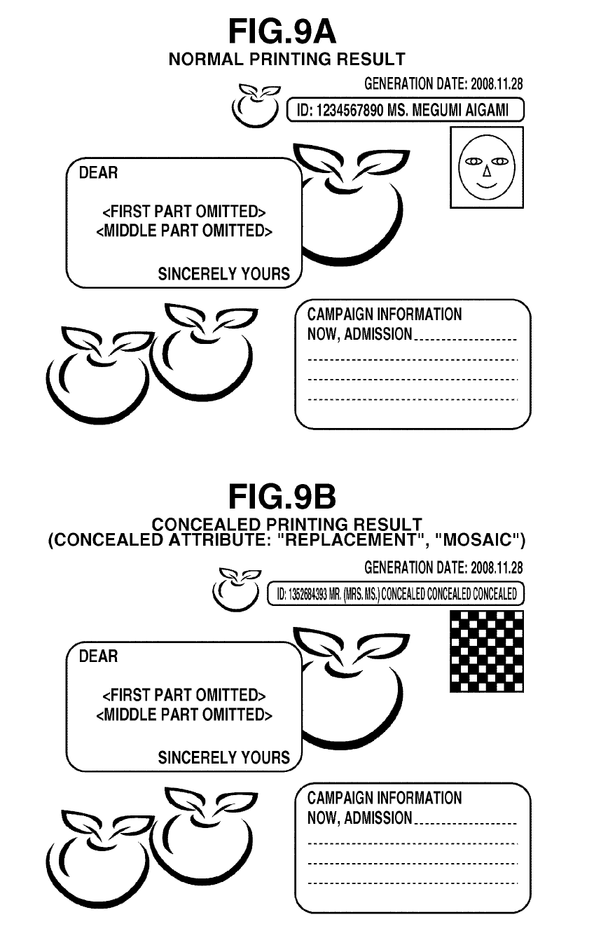

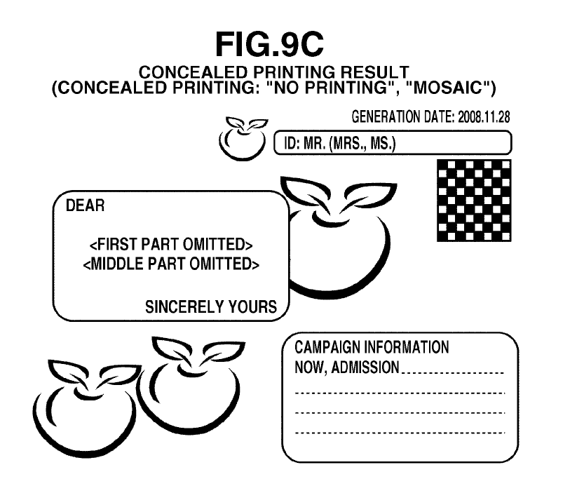

The VDP data analysis unit 202 analyzes the received VDP data to separate a print attribute portion (meta data) and a print data portion (page data, reusable data, and variable data) from the received VDP data. In step S305, the test printing determination unit 203 determines whether there is a test printing command based on the separated print attribute portion or an operation performed by the user via the operation panel 600 of the printing apparatus. In step S309, if there is no test printing command, the normal image generation unit 208 generates a normal image illustrated in FIG. 9A to perform normal printing, and transmits data to the printing mechanism unit 209. FIGS. 9A to 9C illustrate examples of printing results.

On the other hand, if there is a test printing command, the variable data determination unit 204 determines whether the print data portion contains variable data based on the meta data. In step S306, if the print data portion contains variable data, the concealment attribute analysis unit 205 analyzes the meta data of the VDP data to identify concealment attributes corresponding to the variable data.

In step S307, the concealment processing unit 206 performs, according to the concealment attributes identified by the concealment attribute analysis unit 205, concealment processing, such as replacement or mosaic patterning, for the variable data. In step S308, the concealed image generation unit 207 generates a concealed image containing the variable data subjected to concealment processing by the concealment processing unit 206. FIG. 9B illustrates an example of concealment processing and a concealed image when a variable object has “REPLACE” set in a character string and “MOSAIC” set in an image as concealment attributes. FIG. 9C illustrates an example of concealment processing and a concealed image when a variable object has “NOT PRINT” set in a character string and “MOSAIC” set in an image as concealment attributes.

If a concealment attribute is “NOT CONCEAL”, the concealment processing unit 206 skips step S307 of concealed image generation processing that is concealment processing, to proceed to step S308.

This way, a normal image and a concealed image are generated.

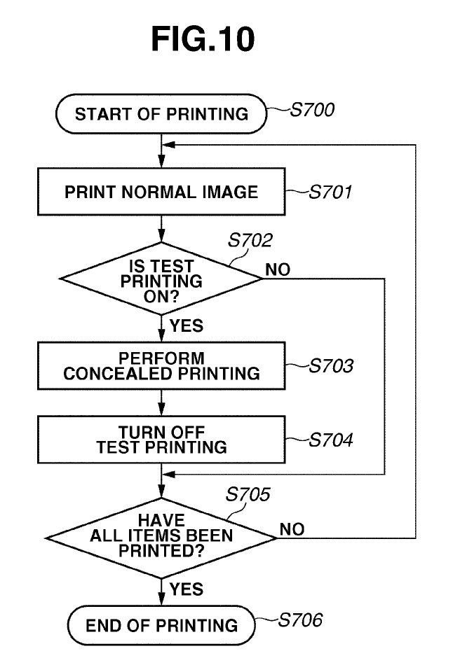

Next, actual printing in the printing apparatus 200 will be described. FIG. 10 is a flowchart illustrating an example of printing in the printing apparatus. The flowchart of FIG. 10 illustrates a flow of processing when during normal printing, the user performs a panel operation of the printing apparatus 200 to interrupt an operation of the printing apparatus 200 with a test printing command.

First, in step S700, the host computer 100 transmits a print job to the printing apparatus 200. The printing apparatus 200 starts printing of a normal image illustrated in FIG. 9A. In step S701, the printing mechanism unit 209 outputs, as a printed matter that is an output of a first page, a normal image generated by the normal image generation unit 208.

In step S702, the test printing determination unit 203 determines whether the operation has been interrupted with a test printing command. An example of interruption with a test printing command is, as described above, a case where the user presses (touches) a “TEST PRINT” button 601 disposed on the operation panel 600 of the body of the printing apparatus 200 illustrated in FIG. 11 during printing. The test printing determination unit 203 performs test printing determination for each item (each page). FIG. 11 illustrates an example of a screen displayed on the panel.

If the test printing determination unit 203 detects interruption with a test printing command (YES in step S702), the printing mechanism unit 209 changes a discharge tray (sample tray) of normal printing to perform concealed printing. In step S703, the concealed image generation unit 207 generates a concealed image to output the discharge tray concealed image. In step S704, after the concealed printing is finished, for example, the test printing determination unit 203 treats the interruption with the test printing command as processed, and deletes the command. An output example of the concealed image is as illustrated in FIG. 9B, where the variable data portion of FIG. 9A is replaced by dummy data and concealed, or concealed in a form of a mosaic image. Alternatively, as illustrated in FIG. 9C, the variable data portion of FIG. 9A can be concealed in an unprinted form.

If there is no test printing command (NO in step S702), the test printing determination unit 203 proceeds to step S705.

In step S705, for example, the printing mechanism unit 209 determines whether all items of pages designated by a print job have been printed. If printing of all the items has been completed (YES In step S705), in step S706, for example, the printing mechanism unit 209 finishes the printing. If printing of all the items has not been completed (NO in step S705), to print a next page, for example, the printing mechanism unit 209 returns to printing of the normal image, and repeats printing until printing of all the items is completed.

Setting of a discharge tray is prepared as one of pair setting items in the printing apparatus 200. The user can designate discharge trays for normal printing and concealed printing via the screen illustrated in FIG. 3.

Next, a second exemplary embodiment will be described by way of example where a printing apparatus 200 side generates dummy data for concealment. A difference from the first exemplary embodiment is that a host computer 100 side prepares no processing for generating dummy data for concealment beforehand. Unlike the first exemplary embodiment, after reception of a print job, the printing apparatus 200 analyzes meta data to identify concealment attributes, performs concealment processing for variable data according to the concealment attributes to generate concealment data, and then generates a concealed image.

Hereinafter, differences from the first exemplary embodiment will mainly be described.

According to the first exemplary embodiment, as illustrated in FIG. 5A, the variable data and the dummy data used for concealment are entered to the DB server 900 beforehand. In the second exemplary embodiment, however, as illustrated in FIG. 5B, no dummy data needs to be prepared beforehand in the DB server 900 side. In the host computer 100 side, during VDP data generation, only concealment attributes and information about a correspondence relation between the concealment attributes and the variable data are described. In the host computer 100 side, only data for normal printing is embedded in print data.

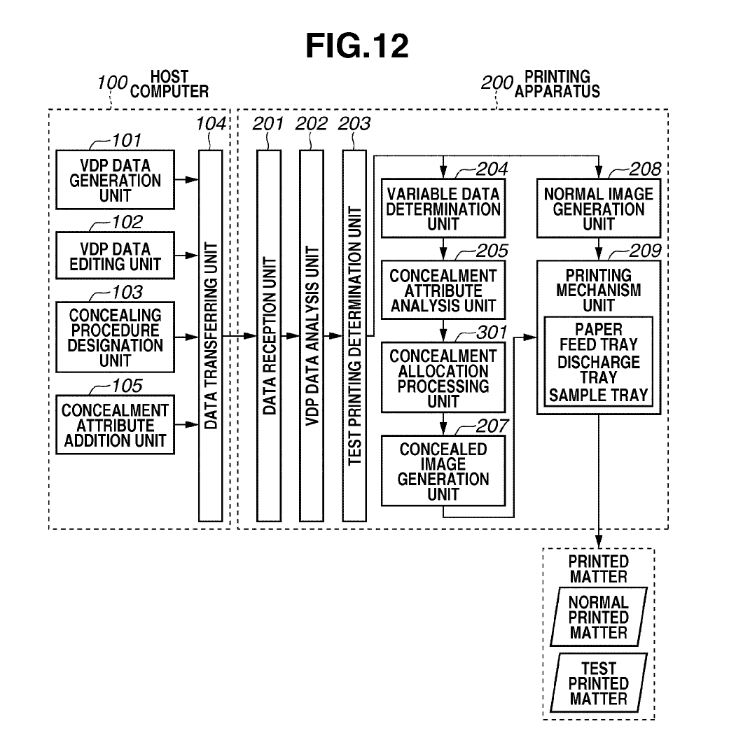

FIG. 12 illustrates a second example (2) of a functional configuration of the host computer and the printing apparatus. Functions similar to those of the first exemplary embodiment are denoted by similar reference numerals, and description thereof will be omitted.

A data transferring unit 104 of this exemplary embodiment converts VDP data containing concealment attributes added by a concealment attribute addition unit 105 as meta data into a description form to be interpreted by the printing apparatus of a transfer destination. The data transferring apparatus 104 transfers data generated as a result of the conversion as a print job to the printing apparatus 200. Unlike the first exemplary embodiment, the print job contains no dummy data for concealment.

Concealment allocation processing unit 301 of the printing apparatus 200 allocates concealment processing of each variable data according to concealment attributes identified by a concealment attribute analysis unit 205. More specifically, based on the concealment attributes identified by the concealment attribute analysis unit 205 and variable data corresponding to the concealment attributes, the concealment allocation processing unit 301 allocates concealment processing to the variable data and the allocated concealment processing. Referring to FIG. 7B, an example of variable data will be described.

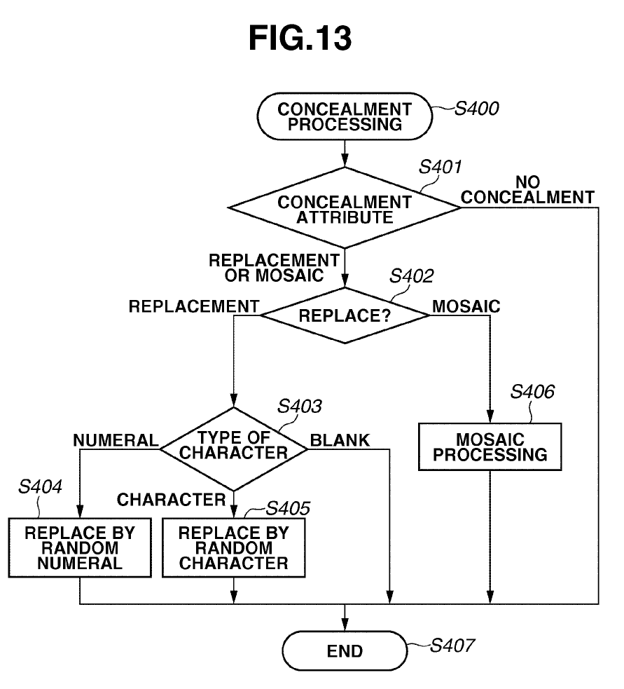

FIG. 13 is a flowchart illustrating an example of concealment processing allocation and execution. Before a start of this flowchart, if a concealment attribute of relevant variable data is “NOT PRINT”, the concealment allocation processing unit 301 ignores processing illustrated in FIG. 13 and does not subject the data to the processing for concealed image generation. In step S400, only when a concealment attribute is one of “REPLACE”, “MOSAIC”, and “NOT CONCEAL”, the process is changed from step S307 of FIG. 8 to the flowchart of FIG. 13.

If the concealment attribute is “REPLACE” or “MOSAIC” (REPLACE or MOSAIC in step S401), the concealment allocation processing unit 301 proceeds to a next concealment processing allocation branch 5402. If the concealment attribute is “NOT CONCEAL” (NOT CONCEAL in step S401), the concealment allocation processing unit 301 directly outputs original data to the concealed image generation unit 207 without performing any concealment processing.

If, in the concealment processing allocation branch 5402, a target concealment attribute is “REPLACE” (REPLACE in step S402), the concealment allocation processing unit 301 proceeds to a character type branch 5403 of a data format. If, in the character type branch, the character type is “NUMERAL” (NUMERAL in step S403), in step S404, the concealment allocation processing unit 301 performs replacement by a random numerical value similar to a numeral portion of FIG. 7C while holding a layout of the same number of characters or the same font. If, in the character type branch, the character type is “CHARACTER” (CHARACTER in step S403), in step S405, the concealment allocation processing unit 301 performs replacement by a random character similar to a character portion of FIG. 7C while holding the layout of the same number of characters or the same font. If, in the character type branch, the character type is “BLANK” (BLANK in step S403), the concealment allocation processing unit 301 maintains the blank state to prevent breakage of the layout by holding the same number of characters or the same font.

If the target concealment attribute is “MOSAIC” (MOSAIC in step S402), in step S406, the concealment allocation processing unit 301 performs mosaic processing as in the case of an image portion of FIG. 7C while holding the layout of the same number of characters or the same font. When the processing of FIG. 8 is completed in step S407, the concealment allocation processing unit 301 passes the variable data subjected to the concealment processing to the concealed image generation unit 207 to proceed to step S308 of FIG. 8.

The objects of the aforementioned exemplary embodiments are achieved as follows. A storage medium (or recording medium) recording a software program code to realize the function of the exemplary embodiment is supplied to a system or an apparatus. A Central Processing Unit (CPU), Micro-Processing Unit (MPU), or the like, of the system or the apparatus reads and executes the program code stored in the storage medium. In this case, the program code itself read from the storage medium realizes the function of the exemplary embodiment, and the storage medium recording the program code is within the exemplary embodiment.

The CPU of the system or the apparatus reads and executes the program code. Then, based on an instruction of the program code, an Operating System (OS) operating on the system or the apparatus performs a part or all parts of actual processing. Realization of the function of the exemplary embodiment by this processing is within the exemplary embodiment.

It is assumed that the program code read from the storage medium is written in a memory provided in a function expansion card inserted into or a function expansion unit connected to the system or the apparatus. Then, based on the instruction of the program code, a CPU of the function expansion card or the function expansion unit performs apart or all parts of actual processing. Realization of the function of the exemplary embodiment is also within the exemplary embodiment.

When the exemplary embodiment is applied to the storage medium, the storage medium stores a program code corresponding to the aforementioned flowchart.

According to each of the exemplary embodiments, concealment processing is executed for a page including a variable object during copy outputting (test printing) in variable data printing even without user's awareness. Thus, information leakage during test printing can be prevented. As to an image, the image is concealed by using mosaic processing as a concealing procedure, holding tints to a certain extent. Thus, the user can perform rough tint checking even when the image is concealed. Further, since attention is focused on features including personal information or classified information in the variable object, only the variable object is subjected to concealment processing. Thus, a processing speed can be increased more than the approach of extracting personal information from all the objects.

In other words, according to each of the exemplary embodiments, information leakage during copy outputting such as test printing can be efficiently prevented.

The exemplary embodiments of the present invention have been described in detail. However, the invention is not limited to the specific exemplary embodiments. Various modifications and changes can be made within a gist of the invention described in the claims.

The information processing apparatus described in the claims corresponds to, for example, the host computer 100. The printing apparatus described in the claims corresponds to, for example, the printing apparatus 200. The computer described in the claims corresponds to, for example, the host computer 100 or the printing apparatus 200.

The present invention can be achieved in a manner that the storage medium recording the software program code to realize the function is supplied to the apparatus, and the computer (CPU, MPU, or the like) of the apparatus reads and executes the program code stored in the recording medium. In this case, the program code itself read from the storage medium realizes the function of the exemplary embodiment, and the storage medium storing the program code is within the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-070867 filed Mar. 23, 2009, which is hereby incorporated by reference herein in its entirety.

What is claimed is:

1. An information processing apparatus comprising:
a designation unit configured to designate a concealing procedure of variable data relating to print data containing reusable data and variable data;
an attribute addition unit configured to add, according to the concealing procedure designated by the designation unit, concealment attributes relating to the concealing procedure of the variable data, to print attributes of the print data in association with the variable data; and
a transferring unit configured to transfer a print job containing information relating to the print data and the print attributes to which the concealment attributes have been added by the attribute addition unit, to a printing apparatus.

2. The information processing apparatus according to claim 1, further comprising an addition unit configured to add information relating to concealment data as dummy data of the variable data whose concealing procedure has been designated by the designation unit, to the print job.

3. The information processing apparatus according to claim 1, wherein the concealing procedure designatable by the designation unit includes at least replacing the variable data with dummy data.

4. The information processing apparatus according to claim 3, further comprising an addition unit configured to add, when the designation unit designates replacing the variable data with the dummy data, information relating to concealment data as dummy data of the variable data whose concealing procedure has been designated by the designation unit, to the print job.

5. The information processing apparatus according to claim 1, wherein the concealing procedure designated by the designation unit includes at least performing mosaic processing on the variable data.

6. The information processing apparatus according to claim 5, wherein the designation unit can designate, only when the variable data is image data, the method for performing mosaic processing on the variable data.

7. A printing apparatus comprising:
a reception unit configured to receive a print job containing information relating to print data containing reusable data and variable data, and print attributes to which concealment attributes relating to a concealing procedure of the variable data of the print data and the variable data have been added in an associated state, from an information processing apparatus;
a concealment processing unit configured to conceal, when a command to output copy is received, the variable data corresponding to the concealment attributes based on the concealment attributes contained in the print attributes received by the reception unit;
a generation unit configured to generate a concealed image containing the reusable data and the variable data concealed by the concealment processing unit; and
a printing mechanism unit configured to control printing of the concealed image generated by the generation unit.

8. The printing apparatus according to claim 7, wherein:
the print job further contains information relating to concealment data as dummy data of the variable data corresponding to the concealment attributes; and
the generation unit obtains the concealment data based on the information, and generates the concealed image by using the obtained concealment data.

9. The printing apparatus according to claim 7, wherein the printing mechanism unit performs control to discharge a printed matter of the concealed image generated by the generation unit to a set tray.

10. The printing apparatus according to claim 7, further comprising a determination unit configured to determine whether the command to output the copy is a test printing command,
wherein the concealment processing unit conceals, when the determination unit determines that the command to output the copy is a test printing command, the variable data corresponding to the concealment attributes.

11. An information processing method comprising:
designating a concealing procedure of variable data relating to print data containing reusable data and variable data by an information processing apparatus;
adding, according to the designated concealing procedure, concealment attributes relating to the concealing procedure of the variable data, to print attributes of the print data in association with the variable data by the information processing apparatus; and
transferring a print job containing information relating to the print data and the print attributes to which the concealment attributes have been added to a printing apparatus by the information processing apparatus.

12. The information processing method according to claim 11, further comprising adding information relating to concealment data as dummy data of the variable data whose concealing procedure has been designated to the print job by the information processing apparatus.

13. A printing method comprising:
receiving, by a printing apparatus, a print job containing information relating to print data containing reusable data and variable data, and print attributes to which concealment attributes relating to a concealing procedure of the variable data of the print data and the variable data have been added in an associated state, from an information processing apparatus;
concealing, by the printing apparatus, when a command to output copy is received, the variable data corresponding to the concealment attributes based on the concealment attributes contained in the received print attributes;
generating, by the printing apparatus, a concealed image containing the reusable data and the concealed variable data; and
controlling, by the printing apparatus, printing of the generated concealed image.

14. The printing method according to claim 13, wherein:
the print job further contains information relating to concealment data as dummy data of the variable data corresponding to the concealment attributes; and
obtaining the concealment data based on the information, and generating the concealed image by using the obtained concealment data.

15. The printing method according to claim 13, further comprising determining whether the command to output the copy is a test printing command by the printing apparatus,
wherein when it is determined that the command to output the copy outputting is a test printing command, the variable data corresponding to the concealment attributes is concealed.

16. A computer readable storage medium storing a program for causing the computer to function as:
a designation unit configured to designate a concealing procedure of variable data relating to print data containing reusable data and variable data;
an attribute addition unit configured to add, according to the concealing procedure designated by the designation unit, concealment attributes relating to the concealing procedure of the variable data, to print attributes of the print data in association with the variable data; and
a transferring unit configured to transfer a print job containing information relating to the print data and the print attributes to which the concealment attributes have been added by the attribute addition unit, to a printing apparatus.

17. A computer readable storage medium storing a program for causing the computer to function as:
a reception unit configured to receive a print job containing information relating to print data containing reusable data and variable data, and print attributes to which concealment attributes relating to a concealing procedure of the variable data of the print data and the variable data have been added in an associated state, from an information processing apparatus;
a concealment processing unit configured to conceal, when a command to output copy is received, the variable data corresponding to the concealment attributes based on the concealment attributes contained in the print attributes received by the reception unit;
a generation unit configured to generate a concealed image containing the reusable data and the variable data concealed by the concealment processing unit; and
a printing mechanism unit configured to control printing of the concealed image generated by the generation unit.
